(19) United States
(12) Patent Application Publication
(10) Pub. No.: US 2026/0180628 A1
(43) Pub. Date: Jun. 25, 2026

(54) USER CLUSTERING IN WIRELESS CHANNEL ENVIRONMENTS

(71) Applicant: SAMSUNG ELECTRONICS CO., LTD., Suwon-si (KR)

(72) Inventors: Wan CHOI, Seoul (KR); Jiyoung YUN, Seoul (KR); Hongjun HEO, Seoul (KR)

(73) Assignee: SAMSUNG ELECTRONICS CO., LTD., Suwon-si (KR)

(21) Appl. No.: 19/423,124

(22) Filed: Dec. 17, 2025

(30) Foreign Application Priority Data
Dec. 19, 2024 (KR) 10-2024-0191708
May 20, 2025 (KR) 10-2025-0065730

(51) Int. Cl. H04B 7/0404

(52) U.S. Cl. CPC H04B 7/0404

(57) ABSTRACT

An operating method of a wireless communication device for communicating with a plurality of communication target devices, may include calculating a plurality of azimuth angles between the plurality of communication target devices and the wireless communication device, respectively, calculating a plurality of communication distances between the plurality of communication target devices and the wireless communication device, respectively, sorting the plurality of communication target devices based on the plurality of azimuth angles and the plurality of communication distances, grouping the sorted plurality of communication target devices into a plurality of user clusters, and generating, based on the plurality of user clusters, a wireless signal to be transmitted to the plurality of communication target devices.

### CROSS-REFERENCE TO RELATED APPLICATIONS

This application is based on and claims priority under 35 U.S.C. § 119 to Korean Patent Application Nos. 10-2024-0191708, filed on Dec. 19, 2024, and 10-2025-0065730, filed on May 20, 2025, in the Korean Intellectual Property Office, the disclosures of which are incorporated by reference herein in their entireties.

### BACKGROUND

The present disclosure relates to a wireless communication device for transmitting a wireless signal by performing clustering.

In a wireless communication system, a base station may communicate with a plurality of user equipment. Herein, the base station may perform clustering on the plurality of user equipment to efficiently transmit a wireless signal to the plurality of user equipment. In this case, to obtain a spatial multiplexing gain, various clustering methods having low complexity have been developed.

### SUMMARY

In one or more embodiments of the present disclosure, an operating method of a wireless communication device for communicating with a plurality of communication target devices, may include: calculating a plurality of azimuth angles between the plurality of communication target devices and the wireless communication device, respectively; calculating a plurality of communication distances between the plurality of communication target devices and the wireless communication device, respectively; sorting the plurality of communication target devices based on the plurality of azimuth angles and the plurality of communication distances; grouping the sorted plurality of communication target devices into a plurality of user clusters; and generating, based on the plurality of user clusters, a wireless signal to be transmitted to the plurality of communication target devices.

In one or more embodiments of the present disclosure, a wireless communication device for communicating with a plurality of communication target devices may include: a processor configured to generate a wireless signal; and a transceiver configured to transmit the wireless signal. The processor is further configured to: calculate a plurality of azimuth angles between the plurality of communication target devices and the wireless communication device, respectively; calculate a plurality of communication distances that are respective distances between the plurality of communication target devices and the wireless communication device; sort the plurality of communication target devices based on the plurality of azimuth angles and the plurality of communication distances; group the sorted plurality of communication target devices into a plurality of user clusters; and generate, based on the plurality of user clusters, the wireless signal to be transmitted to the plurality of communication target devices.

In one or more embodiments of the present disclosure, a method of controlling a base station may include: sorting a plurality of user terminals based on respective azimuth angles between the base station and the plurality of user terminals, and respective communication distances between the base station and the plurality of user terminals; grouping the sorted plurality of user terminals into a plurality of user clusters, by assigning, into a same user cluster, user terminals having an identical remainder resulting from dividing respective sorting indices of the user terminals by a total number of user clusters; and generating, based on the plurality of user clusters, a wireless signal to be transmitted to the plurality of user terminals.

### BRIEF DESCRIPTION OF DRAWINGS

Embodiments of the inventive concept will be more clearly understood from the following detailed description taken in conjunction with the accompanying drawings in which:

FIG. 1 illustrates a wireless communication system according to an embodiment;

FIG. 2 is a block diagram illustrating a wireless communication device according to an embodiment;

FIG. 3 illustrates calculation criteria of the azimuth and the communication distance between a wireless communication device and a communication target device, according to an embodiment;

FIG. 4 illustrates a relationship between a wireless communication device and a plurality of communication target devices, according to an embodiment;

FIG. 5 illustrates that a wireless communication device sorts a plurality of communication target devices based on a plurality of azimuths and a plurality of communication distances, according to an embodiment;

FIG. 6 illustrates that a wireless communication device classifies a sorted plurality of communication target devices into a plurality of user clusters, according to an embodiment;

FIG. 7 illustrates that a wireless communication device classifies a sorted plurality of communication target devices into a plurality of user clusters, according to another embodiment;

FIG. 8 illustrates that a wireless communication device classifies a sorted plurality of communication target devices into a plurality of user clusters, according to another embodiment;

FIG. 9 is a flowchart illustrating an operating method of a wireless communication device, according to an embodiment;

FIG. 10 is a flowchart illustrating a particular method of sorting a plurality of communication target devices in an operating method of a wireless communication device, according to an embodiment;

FIG. 11 is a flowchart illustrating a particular method of secondarily sorting a plurality of communication target devices in an operating method of a wireless communication device, according to an embodiment;

FIG. 12 is a flowchart illustrating a method of generating a wireless signal in an operating method of a wireless communication device, according to an embodiment; and

FIG. 13 is a block diagram illustrating a wireless communication device according to an embodiment.

### DETAILED DESCRIPTION

In the present disclosure, the term “an embodiment” is intended to encompass one or more embodiments, rather than being limited to a single example. Furthermore, features described in embodiments may be combined and implemented together.

Hereinafter, embodiments are described in detail with reference to the accompanying drawings.

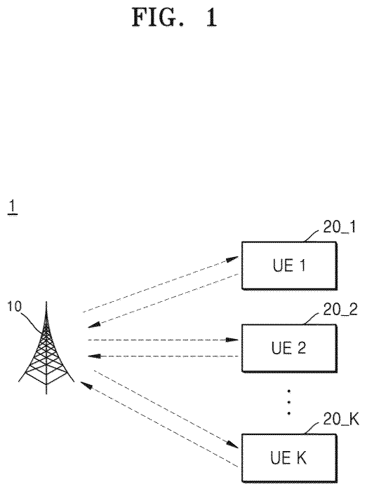

FIG. 1 illustrates a wireless communication system 1 according to an embodiment.

Referring to FIG. 1, the wireless communication system 1 according to an embodiment may include a base station 10 and a plurality of user equipments (UEs) 20_1 to 20_K.

The wireless communication system 1 may provide a communication service based on at least one of a plurality of wireless networks to the plurality of UEs 20_1, 20_2, . . . , 20_K. For example, the wireless communication system 1 may provide a communication service based on at least one of a 3rd generation (3G) network, a 4th generation (4G) network, a wireless broadband (Wibro) network, a global system for mobile communication (GSM) network, a 5th generation (5G) network, and a 6th generation (6G) network.

Various functions described below may be implemented or supported by the artificial intelligence (AI) technology or one or more computer programs, and each of the computer programs includes computer-readable program code and is stored in a computer-readable medium. The terms “application” and “program” are referred to as one or more computer programs, software components, instruction sets, procedures, functions, objects, classes, instances, related data, or some thereof suitable for implementing suitable computer-readable program code. The term “computer-readable program code” includes all types of computer code including source code, object code, and execution code. The term “computer-readable medium” includes all types of computer-accessible media, such as read-only memory (ROM), random access memory (RAM), a hard disk drive, a compact disc (CD), a digital video disc (DVD), or other types of memories. A non-transitory computer-readable medium excludes wired, wireless, optical, or other communication links configured to transmit transitory electrical or other signals. A non-transitory computer-readable medium includes a medium in which data may be permanently stored and a medium, such as a re-writable optical disc or an erasable memory device, in which data is stored and may be over-written later.

In the embodiments described below, a hardware approach is illustrated. However, because the embodiments include techniques using both hardware and software, the embodiments do not exclude a software-based approach.

The base station 10 may represent a fixed station configured to communicate with the plurality of UEs 20_1 to 20_K, and may exchange control information and data with the plurality of UEs 20_1 to 20_K. For example, the base station 10 may be variously referred to as a Node B, an evolved-Node B (eNB), a next generation Node B (gNB), a sector, a site, a base transceiver system (BTS), an access point (AP), a relay node, a remote radio head (RRH), a radio unit (RU), a small cell, a wireless device, a device, or the like.

Although FIG. 1 shows an embodiment in which the wireless communication system 1 includes one base station 10, the inventive concept is not limited thereto. Unlike shown in FIG. 1, the wireless communication system 1 may include two or more base stations 10.

The plurality of UEs 20_1 to 20_K may be fixed or mobile and may represent any type of device configured to transmit and receive data and/or control information to and from the base station 10 by communicating with the base station 10. For example, each of the plurality of UEs 20_1 to 20_K may be referred to as a terminal, terminal equipment, a mobile station (MS), a mobile terminal (MT), a user terminal (UT), a subscribe station (SS), a wireless communication device, a wireless device, a handheld device, a communication target device, or the like.

The base station 10 may communicate with the plurality of UEs 20_1 to 20_K by using a plurality of antennas. In this case, the plurality of antennas may be included in the base station 10 and the plurality of UEs 20_1 to 20_K in the form of an antenna array. For example, the antenna array may have a plate-shaped structure.

The base station 10 may transmit a wireless signal to the plurality of UEs 20_1 to 20_K by using the plurality of antennas. In addition, the plurality of UEs 20_1 to 20_K may receive a wireless signal transmitted by the base station 10 by using the plurality of antennas.

In this case, when the number of UEs 20_1 to 20_K is greater than the number of antennas, the base station 10 may efficiently perform resource allocation by performing user clustering.

In an embodiment, the base station 10 may sort the plurality of UEs 20_1 to 20_K based on a plurality of azimuths that are the respective angles between the plurality of UEs 20_1 to 20_K and the base station 10 and a plurality of communication distances that are the respective distances between the plurality of UEs 20_1 to 20_K and the base station 10, classify the sorted plurality of UEs 20_1 to 20_K into a plurality of user clusters, and transmit a wireless signal to the plurality of UEs 20_1 to 20_K based on the plurality of user clusters. The base station 10 may transmit the wireless signal to the plurality of UEs 20_1 to 20_K based on the plurality of user clusters generated based on the plurality of azimuths and the plurality of communication distances to perform clustering so as to have high transmission efficiency with a small delay time, thereby transmitting the wireless signal to the plurality of UEs 20_1 to 20_K at the high transmission efficiency.

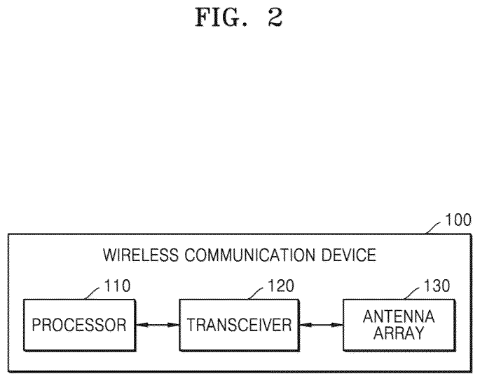

FIG. 2 is a block diagram illustrating a wireless communication device 100 according to an embodiment.

Referring to FIG. 2, the wireless communication device 100 according to an embodiment may include a processor 110, a transceiver 120, and an antenna array 130. The wireless communication device 100 according to an embodiment may be the base station 10 included in the wireless communication system 1 of FIG. 1, but the embodiment is not limited thereto.

The wireless communication device 100 may communicate with a plurality of communication target devices. The plurality of communication target devices may correspond to the plurality of UEs 20_1 to 20_K included in the wireless communication system 1 of FIG. 1, but the embodiment is not limited thereto.

The processor 110 may control a general operation of the wireless communication device 100, and may be configured with an architecture suitable for such control. In an embodiment, the processor 110 may include a communication processor. The processor 110 may generate a wireless signal to be transmitted to the plurality of communication target devices.

The transceiver 120 may transmit the wireless signal to the plurality of communication target devices via the antenna array 130. The transceiver 120 may modulate and amplify the wireless signal generated by the processor 110 and transmit the modulated and amplified wireless signal to the plurality of communication target devices via the antenna array 130.

The antenna array 130 may include a plurality of antennas. The plurality of antennas included in the antenna array 130 may be arranged in a previously determined arrangement. For example, the antenna array 130 may have a plate-shaped structure, and the plurality of antennas may be arranged on a two-dimensional plane.

In an embodiment, the processor 110 may sort the plurality of communication target devices based on a plurality of azimuths and a plurality of communication distances, classify the sorted plurality of communication target devices into a plurality of user clusters, and transmit a wireless signal to the plurality of communication target devices based on the plurality of user clusters.

More particularly, the processor 110 may calculate the plurality of azimuths. The plurality of azimuths may be the respective angles between the plurality of communication target devices and the wireless communication device 100. The plurality of azimuths may be the respective angles between reference lines, which are referred to as a plurality of connection lines and a central line of intersection that extends from the center point of the antenna array 130 of the wireless communication device 100 to the center point of the antenna array of each communication target device. Herein, the plurality of connection lines may be the respective lines connecting the centers of antenna arrays of the plurality of communication target devices to the central point of intersection of the antenna array 130 of the wireless communication device 100. The central point of intersection may be the point of intersection between the center of the antenna array 130 of the wireless communication device 100 and the ground when the antenna array 130 of the wireless communication device 100 is parallelly moved in the vertical direction such that the center of the antenna array 130 of the wireless communication device 100 is located on the ground. The central line of intersection may be the line of intersection between the antenna array 130 of the wireless communication device 100 and the ground when the antenna array 130 of the wireless communication device 100 is parallelly moved in the vertical direction such that the center of the antenna array 130 of the wireless communication device 100 is located on the ground.

In addition, the processor 110 may calculate the plurality of communication distances. The plurality of communication distances may be the respective distances between the plurality of communication target devices and the wireless communication device 100. The plurality of communication distances may be the respective distance between the centers of antenna arrays of the plurality of communication target devices and the center of the antenna array 130 of the wireless communication device 100.

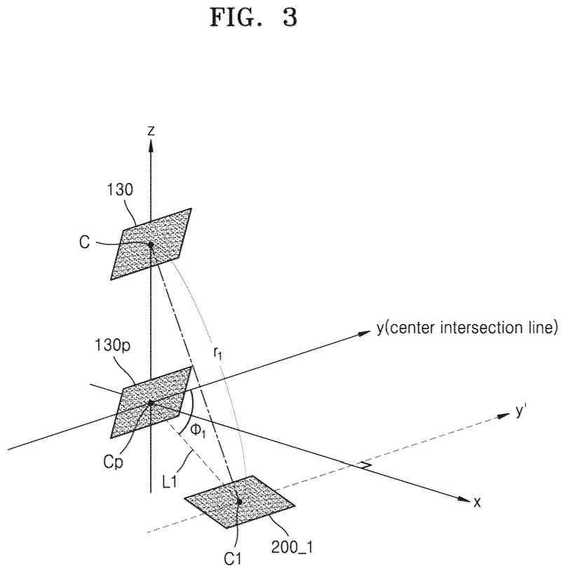

Criteria for calculating an azimuth and a communication distance may be described more particularly with reference to FIG. 3.

FIG. 3 illustrates criteria for calculating the azimuth and the communication distance between a wireless communication device and a communication target device, according to an embodiment.

Referring to FIG. 3, the antenna array 130 of the wireless communication device 100 and a first antenna array 200_1 of a first communication target device among a plurality of communication target devices are shown on a coordinate axis.

A first azimuth φ₁ may be the angle between the wireless communication device 100 and the first communication target device. In this case, the first azimuth φ₁ may be the angle between a first connection line L1 and a central line of intersection.

The first connection line L1 may be the line connecting a center C1 of the first antenna array 200_1 of the first communication target device to a central point of intersection Cp of the antenna array 130 of the wireless communication device 100. The central point of intersection Cp may be the point of intersection where a center C of the antenna array 130 of the wireless communication device 100 intersects the ground plane (i.e., the y-z plane in FIG. 3) when the antenna array 130 of the wireless communication device 100 is vertically projected onto the ground. That is, the center of a parallelly moved antenna array 130p (also referred to as ground-projected antenna array 130p) may be the central point of intersection Cp (the origin point in the embodiment of FIG. 3).

The central line of intersection may be the line of intersection between the parallelly moved antenna array 130p and the ground and correspond to the y-axis in the embodiment of FIG. 3.

To sum up, the first azimuth φ₁ in the embodiment of FIG. 3 may be the angle between the first connection line L1 and the y-axis that is the central line of intersection.

A first communication distance r₁ may be the distance between the wireless communication device 100 and the first communication target device. Herein, the first communication distance r₁ may be the distance between the center C of the antenna array 130 of the wireless communication device 100 and the center C1 of the first antenna array 200_1.

Referring back to FIG. 2, the processor 110 may calculate the plurality of azimuths and the plurality of communication distances based on the same criteria as described above with reference to FIG. 3. In this case, the processor 110 may calculate the plurality of azimuths and the plurality of communication distances by using commonly known methods.

The processor 110 may sort the plurality of communication target devices based on the plurality of azimuths and the plurality of communication distances.

First, the processor 110 may primarily sort the plurality of communication target devices based on the plurality of azimuths. Hereinafter, the primary sorting may indicate sorting based on the plurality of azimuths to form an azimuth-ordered list. In an embodiment, the processor 110 may primarily sort the plurality of communication target devices in an ascending order of the plurality of azimuths. In another embodiment, the processor 110 may primarily sort the plurality of communication target devices in a descending order of the plurality of azimuths.

Next, the processor 110 may secondarily sort the primarily sorted plurality of communication target devices based on the plurality of communication distances to form a distance-ordered list. Hereinafter, the secondary sorting may indicate sorting based on the plurality of communication distances.

The processor 110 may select communication target devices on which the secondary sorting is to be performed from among the primarily sorted plurality of communication target devices based on the beamwidth of the wireless communication device 100. In other words, from among the primarily-sorted plurality of communication target devices, a subset of communication target devices is selected based on the beam width before the secondary-sorting is applied. The beamwidth of the wireless communication device 100 may be a value determined according to the arrangement of the plurality of antennas included in the antenna array 130 of the wireless communication device 100. For example, the processor 110 may select communication target devices on which the secondary sorting is to be performed from among the plurality of communication target devices based on Mathematical formula 1 below.

$$cos {ϕ}_{i + j} - cos {ϕ}_{i} < \frac{1}{{N}_{t}} \qquad [ Mathematical formula 1 ]$$

In Mathematical formula 1, φᵢ may be the azimuth of a communication target device primarily sorted in an i-th order, φᵢ₊ⱼ may be the azimuth of a communication target device primarily sorted in an (i+j)-th order, and Nₜ may be the beamwidth of the wireless communication device 100. 1/N₁ may represent an angular resolution (or directional selectivity) of the wireless communication device 100. When Mathematical formula 1 is satisfied, the processor 110 may select, as communication target devices on which the secondary sorting is to be performed, the communication target device primarily sorted in the i-th order to the communication target device primarily sorted in the (i+j)-th order. For example, when i=3 and j=2, a total of three communication target devices that are a communication target device primarily sorted in a third order to a communication target device primarily sorted in a fifth order may be selected as communication target devices on which the secondary sorting is to be performed. Mathematical formula 1 may be used to determine which communication target devices are close enough in direction (azimuth angle) to be reached by the same beam. If the difference in direction between two communication target devices, which are expressed using the cosine of their angles, is small enough, it indicates that the communication target devices are close together in direction. In that case, both communication target devices can be reached by the same beam and may be selected for further sorting. Mathematical formula 1 may be used to filter out communication target devices that are too far apart in direction, as they cannot be reached by the same beam.

The processor 110 may secondarily sort the communication target devices selected to be secondarily sorted, based on the plurality of communication distances. In an embodiment, the processor 110 may secondarily sort the communication target devices selected to be secondarily sorted, in an ascending order of the plurality of communication distances. In another embodiment, the processor 110 may secondarily sort the communication target devices selected to be secondarily sorted, in a descending order of the plurality of communication distances.

The embodiments of the present disclosure are not limited to performing the primary sorting operation before the secondary sorting operation. In one or more embodiments, the order may be reversed such that the secondary sorting operation is performed before the primary sorting operation, or the sorting may be performed by simultaneously considering both azimuth angles and communication distances.

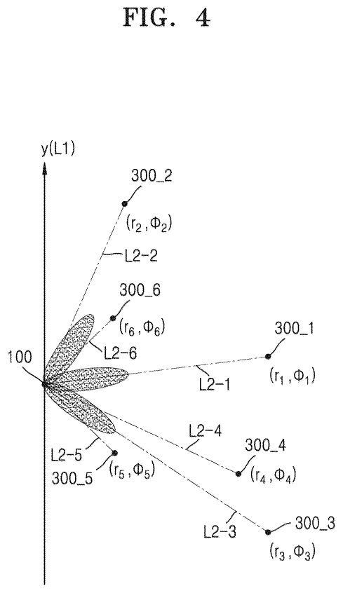

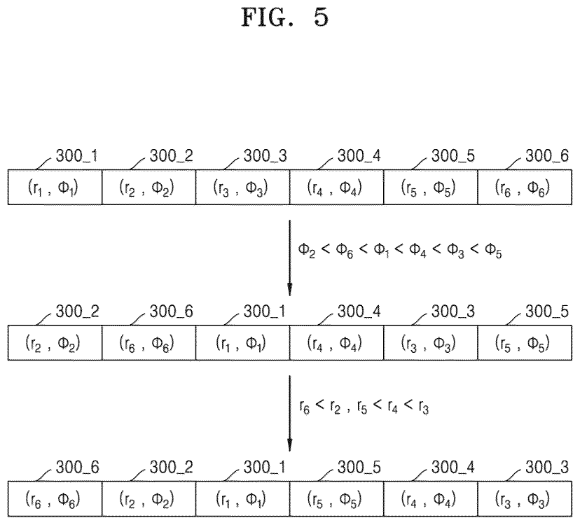

An embodiment in which the processor 110 sorts the plurality of communication target devices based on the plurality of azimuths and the plurality of communication distances may be described with reference to FIGS. 4 and 5.

FIG. 4 illustrates a relationship between the wireless communication device 100 and a plurality of communication target devices, e.g., first to sixth communication target devices 300_1 to 300_6, according to an embodiment.

Referring to FIG. 4, a relationship between the wireless communication device 100 and the first to sixth communication target devices 300_1 to 300_6 is simply illustrated. The drawing of FIG. 4 may be an example of the relationship between the wireless communication device 100 and the first to sixth communication target devices 300_1 to 300_6 when the wireless communication device 100 and the first to sixth communication target devices 300_1 to 300_6 are viewed downward from the top of the z-axis in the same coordinate axis as shown in FIG. 3. Although FIG. 4 shows an embodiment in which six communication target devices (that is, the first to sixth communication target devices 300_1 to 300_6) are included in the wireless communication system 1, the inventive concept is not limited thereto.

The first to sixth communication target devices 300_1 to 300_6 may be represented based on a communication distance and an azimuth. For example, the first communication target device 300_1 may be represented by the first communication distance r₁ that is the distance between the first communication target device 300_1 and the wireless communication device 100 and the first azimuth φ₁ that is the angle between the first communication target device 300_1 and the wireless communication device 100 and, for example, represented by (r₁, φ₁). Likewise, the second communication target device 300_2 may be represented by (r₂, φ₂), the third communication target device 300_3 may be represented by (r₃, φ₃), the fourth communication target device 300_4 may be represented by (r₄, φ₄), the fifth communication target device 300_5 may be represented by (r₅, φ₅), and the sixth communication target device 300_6 may be represented by (r₆, φ₆).

FIG. 5 illustrates that a wireless communication device sorts a plurality of communication target devices based on a plurality of azimuths and a plurality of communication distances, according to an embodiment.

Referring to FIG. 5, when the relationship between the wireless communication device 100 and the first to sixth communication target devices 300_1 to 300_6 is the same as shown in FIG. 4, the processor 110 may sort the first to sixth communication target devices 300_1 to 300_6 based on a plurality of azimuths, e.g., first to sixth azimuths φ₁˜φ₆ and a plurality of communication distances, e.g., first to sixth communication distances r₁ to r₆.

The table at the top of FIG. 5 may indicate a state in which the first to sixth communication target devices 300_1 to 300_6 are not sorted yet. In this state, the processor 110 may primarily sort the first to sixth communication target devices 300_1 to 300_6 based on the first to sixth azimuths φ₁˜φ₆.

In the embodiment of FIG. 4, each of the first to sixth azimuths φ₁˜φ₆ may be the angle between the y-axis (i.e., the first connection line L1) and center intersection lines L2-1, L2-2, L2-3, L2-4, L2-5, and L2-6 that connect the wireless communication device 100 to the first to sixth communication target devices 300_1 to 300_6, respectively. In the embodiment of FIG. 4, the order relation of the first to sixth azimuths φ₁˜φ₆ may be the same as Mathematical formula 2 below.

$${ϕ}_{2} < {ϕ}_{6} < {ϕ}_{1} < {ϕ}_{4} < {ϕ}_{3} < {ϕ}_{5} \qquad [ Mathematical formula 2 ]$$

The processor 110 may primarily sort the first to sixth communication target devices 300_1 to 300_6 based on Mathematical formula 2. The processor 110 may sort the first to sixth communication target devices 300_1 to 300_6 in an ascending order of the first to sixth azimuths φ₁˜φ₆, and a result of the primary sorting may be the same as the table in the middle of FIG. 5. That is, the processor 110 may primarily sort the first to sixth communication target devices 300_1 to 300_6 in the order of the second communication target device 300_2, the sixth communication target device 300_6, the first communication target device 300_1, the fourth communication target device 300_4, the third communication target device 300_3, and the fifth communication target device 300_5.

Next, the processor 110 may secondarily sort the primarily sorted first to sixth communication target devices 300_1 to 300_6 based on the first to sixth communication distances r₁ to r₆. More particularly, the processor 110 may select communication target devices on which the secondary sorting is to be performed from among the primarily sorted first to sixth communication target devices 300_1 to 300_6 based on the beamwidth of the wireless communication device 100. For example, the processor 110 may select communication target devices on which the secondary sorting is to be performed, based on Mathematical formula 1.

In the embodiment of FIG. 4, the processor 110 may select, as communication target devices on which the secondary sorting is to be performed, the second communication target device 300_2 primarily sorted in the first order and the sixth communication target device 300_6 primarily sorted in the second order. For example, this selection may be based on mathematical formula 1, which determines whether the azimuth angles of the two devices are sufficiently close, that is, within the beam width of the wireless communication device 100, to allow them to be reached by the same beam.

In addition, in the embodiment of FIG. 4, the processor 110 may select, as communication target devices on which the secondary sorting is to be performed, the fourth communication target device 300_4 primarily sorted in the fourth order, the third communication target device 300_3 primarily sorted in the fifth order, and the fifth communication target device 300_5 primarily sorted in the sixth order. This selection may satisfy mathematical formula 1, indicating that the azimuth angle differences between the communication target devices 300_3, 300_4 and 300_5 fall within the allowable beam width. Accordingly, the processor 110 may select the fourth communication target device 300_4, the third communication target device 300_3, and the fifth communication target device 300_5 as communication target devices on which the second sorting is to be performed.

In the embodiment of FIG. 5, the second communication distance r₂ may be greater than the sixth communication distance r₆. In addition, the third communication distance r₃ may be greater than the fourth communication distance r₄, the fourth communication distance r₄ may be greater than the fifth communication distance r₅, and these may be the same as Mathematical formula 3.

$${r}_{6} < {r}_{2} , {r}_{5} < {r}_{4} < {r}_{3} \qquad [ Mathematical formula 3 ]$$

The processor 110 may secondarily sort the first to sixth communication target devices 300_1 to 300_6 based on Mathematical formula 3. The processor 110 may sort the first to sixth communication target devices 300_1 to 300_6 in an ascending order of the first to sixth communication distances r₁ to r₆ among the selected communication target devices, and a result of the secondary sorting may be the same as the table at the bottom of FIG. 5. That is, the processor 110 may secondarily sort the first to sixth communication target devices 300_1 to 300_6 in the order of the sixth communication target device 300_6, the second communication target device 300_2, the first communication target device 300_1, the fifth communication target device 300_5, the fourth communication target device 300_4, and the third communication target device 300_3.

Referring back to FIG. 3, the processor 110 may classify the sorted plurality of communication target devices into a plurality of user clusters. The processor 110 may classify the plurality of communication target devices into the plurality of user clusters based on sorting indices. The sorting indices may be allocated to the plurality of communication target devices in a sorting order after the plurality of communication target devices are sorted based on the plurality of azimuths and the plurality of communication distances.

In an embodiment, the processor 110 may classify the sorted plurality of communication target devices into the plurality of user clusters such that the intervals between the sorting indices of communication target devices included in each of the plurality of user clusters are the same as each other.

In another embodiment, the processor 110 may classify, into a same user cluster, communication target devices having the same remainder as the remainder of a result of dividing a sorting index by the number of user clusters.

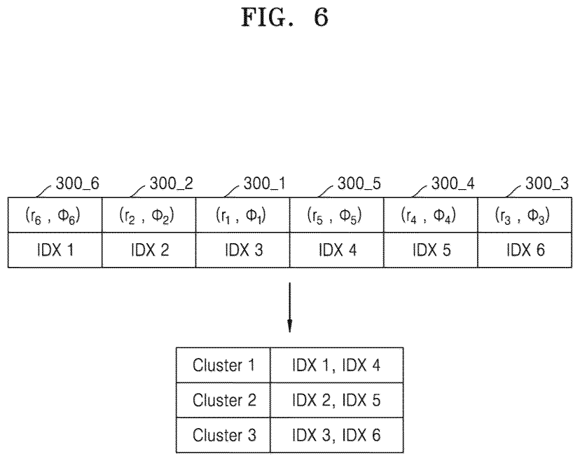

Embodiments in which the processor 110 classifies a plurality of communication target devices into a plurality of user clusters may be described with reference to FIGS. 6 to 8.

FIG. 6 illustrates that a wireless communication device classifies a sorted plurality of communication target devices into a plurality of user clusters, according to an embodiment.

Referring to FIG. 6, the respective sorting indices of the secondarily sorted first to sixth communication target devices 300_1 to 300_6 as shown in FIG. 5 and a plurality of user clusters based on the sorting indices are illustrated.

The processor 110 may assign a sorting index (IDX) of 1 to the sixth communication target device 300_6, which is ranked first in the secondary sorting. The processor 110 may assign a sorting index of 2 to the second communication target device 300_2, which is ranked second in the secondary sorting. The processor 110 may assign a sorting index of 3 to the first communication target device 300_1, which is ranked third in the secondary sorting. The processor 110 may assign a sorting index of 4 to the fifth communication target device 300_5, which is ranked fourth in the secondary sorting. The processor 110 may assign a sorting index of 5 to the fourth communication target device 300_4, which is ranked fifth in the secondary sorting. The processor 110 may assign a sorting index of 6 to the third communication target device 300_3, which is ranked sixth in the secondary sorting.

The processor 110 may group communication target devices into the same user cluster if they share the same remainder when their sorting index is divided by the total number of user clusters.

In the embodiment of FIG. 6, the processor 110 may classify communication target devices with sorting indices of 1 and 4 into a first user cluster, as they yield a remainder of 1 when divided by the number of user clusters (i.e., 3). That is, the processor 110 may classify the sixth communication target device 300_6 and the fifth communication target device 300_5 into the first user cluster.

In addition, the processor 110 may classify communication target devices with sorting indices of 2 and 5 into a second user cluster, as they yield a remainder of 2 when divided by the number of user clusters. That is, the processor 110 may classify the second communication target device 300_2 and the fourth communication target device 300_4 into the second user cluster.

Finally, the processor 110 may classify communication target devices with sorting indices of 3 and 6 into a third user cluster, as they yield a reminder of 0 when divided by the number of user clusters. That is, the processor 110 may classify the first communication target device 300_1 and the third communication target device 300_3 into the third user cluster.

The processor 110 groups communication target devices into clusters by dividing their sorting indices by the total number of clusters and assigning them based on the remainder. This ensures that communication target devices with evenly spaced indices (e.g., 1 and 4, 2 and 5) are distributed across different clusters in a balanced and systematic way.

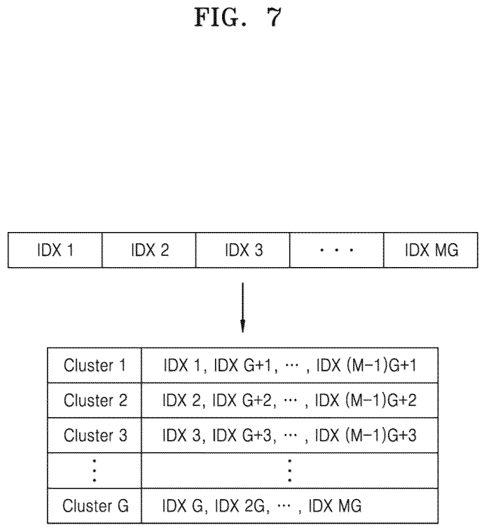

FIG. 7 illustrates that a wireless communication device classifies a sorted plurality of communication target devices into a plurality of user clusters, according to another embodiment.

Referring to FIG. 7, an embodiment is illustrated in which a plurality of communication target devices are grouped into a plurality of user clusters. In this case, a total number of user clusters may be G (G is a natural number), and a total number of communication target devices may be MG (M is a natural number), and sorting indices assigned to the communication target devices may range from 1 to MG.

The processor 110 may classify the sorted plurality of communication target devices into the plurality of user clusters such that the sorting indices of communication target devices within each of the plurality of user clusters follow equal intervals.

In the embodiment shown in FIG. 7, the sorting indices of communication target devices included in a first user cluster are 1, G+1, 2G+1, . . . , and (M−1)G+1, forming a consistent interval of G between each index. That is, the processor 110 may classify the sorted plurality of communication target devices into the plurality of user clusters such that the intervals between the sorting indices of the communication target devices included in the first user cluster is G that is the same interval.

In addition, in the embodiment shown in FIG. 7, a second user cluster includes 2, G+2, 2G+2, . . . , and (M−1)G+2, also with an interval of G. That is, the processor 110 may classify the sorted plurality of communication target devices into the plurality of user clusters such that the intervals between the sorting indices of the communication target devices included in the second user cluster is G that is the same interval.

This pattern continues such that the G-th user cluster includes communication target devices with sorting indices G, 2G, 3G, . . . , and MG, maintaining the same interval of G between them. That is, the processor 110 may classify the sorted plurality of communication target devices into the plurality of user clusters such that the intervals between the sorting indices of the communication target devices included in the G-th user cluster is G that is the same interval.

As described above, the processor 110 may group communication target devices into clusters by assigning them based on regularly spaced sorting indices, where each cluster contains devices separated by a fixed interval G. This structured clustering improves the efficiency and gain of wireless signal transmission.

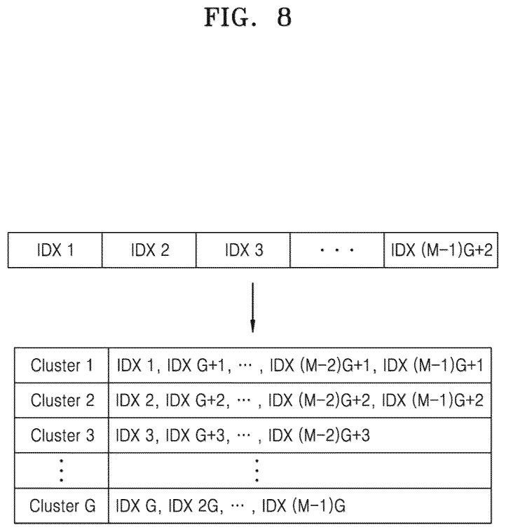

FIG. 8 illustrates that a wireless communication device classifies a sorted plurality of communication target devices into a plurality of user clusters, according to another embodiment.

Referring to FIG. 8, an embodiment is illustrated that is similar to the embodiment shown in FIG. 7, but unlike FIG. 7, the numbers of communication target devices in each user cluster is not uniform, as the total number of communication target devices is (M−1)G+2.

In the embodiment shown in FIG. 8, the processor 110 may classify communication target devices into a first user cluster and a second user cluster in the same manner as described in FIG. 7. In this case, the number of communication target devices classified into each of the first user cluster and the second user cluster may be M.

However, in the embodiment shown in FIG. 8, the sorting indices of communication target devices included in a third user cluster are 3, G+3, 2G+3, . . . , (M−2)G+3, maintaining a constant interval G between adjacent indices. That is, the processor 110 may classify the sorted plurality of communication target devices into the plurality of user clusters such that the intervals between the sorting indices of the communication target devices included in the third user cluster is G that is the same interval. In this case, the number of communication target devices classified into the third user cluster is M−1, fewer than the first user cluster and the second user cluster.

This pattern continues, and a G-th user cluster includes communication target devices with sorting indices G, 2G, 3G, . . . , and (M−1)G, also following an interval of G. Like the third through (G−1)-th clusters, the G-th cluster contains M−1 devices, which is fewer than the first and second clusters.

As described above, even when the number of communication target devices is not evenly divisible by the number of user clusters, the processor 110 may still group the plurality of communication target devices into a plurality of user clusters using the same interval-based clustering method, resulting in some clusters having one fewer device. By doing this, a wireless signal may be transmitted to the plurality of communication target devices with a high gain.

Referring back to FIG. 3, the processor 110 may generate a wireless signal to be transmitted to the plurality of communication target devices, based on the plurality of user clusters.

More particularly, the processor 110 may determine a plurality of beamforming matrices for the plurality of user clusters, respectively. The processor 110 may determine the plurality of beamforming matrices by using beamforming techniques. For example, the processor 110 may generate several beamforming matrices, one for each communication target device, to focus transmission energy toward each communication target device while minimizing interference with nearby communication target devices. To do this, the processor 110 may first sort the communication target devices and then calculate a phase-adjusted discrete Fourier transform matrix for each one, based on the antenna phase shifts and the wireless channel characteristics. Using these phase-change matrices, the processor 110 may derive each beamforming matrix by adjusting it to remove overlapping signal components from neighboring communication target devices.

The processor 110 may generate a wireless signal by multiplying the plurality of beamforming matrices by a plurality of transmission target signals to be transmitted to the plurality of user clusters, respectively. For example, the processor 110 may generate a wireless signal by multiplying a first beamforming matrix by a first transmission target signal to be transmitted to the first user cluster.

As described above, the processor 110 according to an embodiment may classify a plurality of communication target devices into a plurality of user clusters based on a plurality of azimuths and a plurality of communication distances and transmit a wireless signal to the plurality of communication target devices based on the plurality of user clusters. As described above, by classifying the plurality of communication target devices into the plurality of user clusters based on the plurality of azimuths and the plurality of communication distances, clustering may be performed to have high transmission efficiency with a small delay time, thereby transmitting the wireless signal to the plurality of communication target devices at the high transmission efficiency.

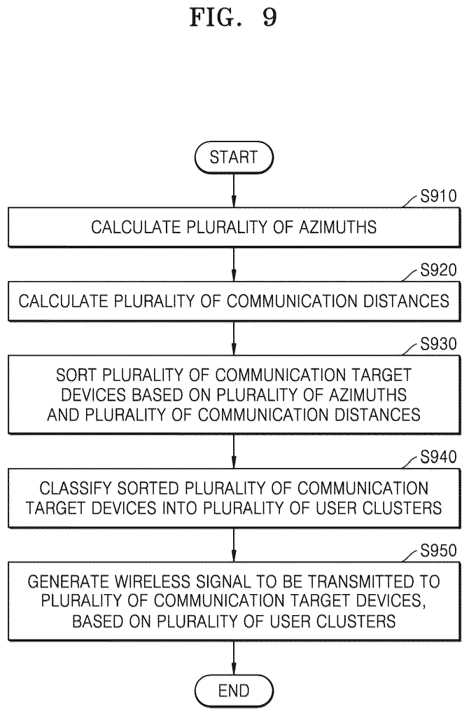

FIG. 9 is a flowchart illustrating an operating method of a wireless communication device, according to an embodiment.

Referring to FIG. 9, in operation S910, the wireless communication device 100 may calculate a plurality of azimuths. The wireless communication device 100 may calculate, as the plurality of azimuths, the respective angles between a plurality of connection lines and a central line of intersection.

In operation S920, the wireless communication device 100 may calculate a plurality of communication distances. The wireless communication device 100 may calculate, as the plurality of communication distances, the respective distances of the centers of antenna arrays of a plurality of communication target devices and the center of the antenna array 130 of the wireless communication device 100.

Although FIG. 9 shows an embodiment of calculating the plurality of azimuths in operation S910 and then calculating the plurality of communication distances in operation S920, the embodiment is not limited thereto. In some embodiments, operation S920 may be performed before or simultaneously with operation S910.

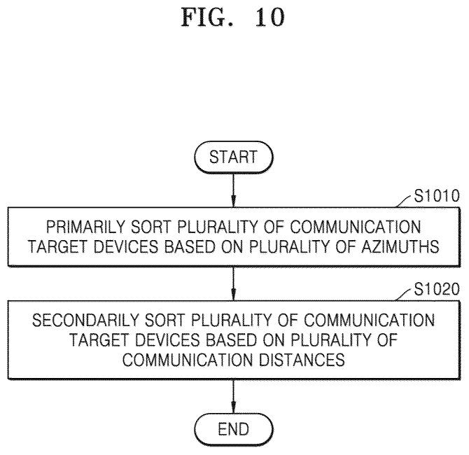

In operation S930, the wireless communication device 100 may sort the plurality of communication target devices based on the plurality of azimuths and the plurality of communication distances. This may be described in more detail with reference to FIG. 10.

FIG. 10 is a flowchart illustrating a particular method of sorting the plurality of communication target devices in the operating method of a wireless communication device, according to an embodiment.

Referring to FIG. 10, in operation S1010, the wireless communication device 100 may primarily sort the plurality of communication target devices based on the plurality of azimuths. In an embodiment, the wireless communication device 100 may primarily sort the plurality of communication target devices in an ascending order of the plurality of azimuths. In another embodiment, the wireless communication device 100 may primarily sort the plurality of communication target devices in a descending order of the plurality of azimuths.

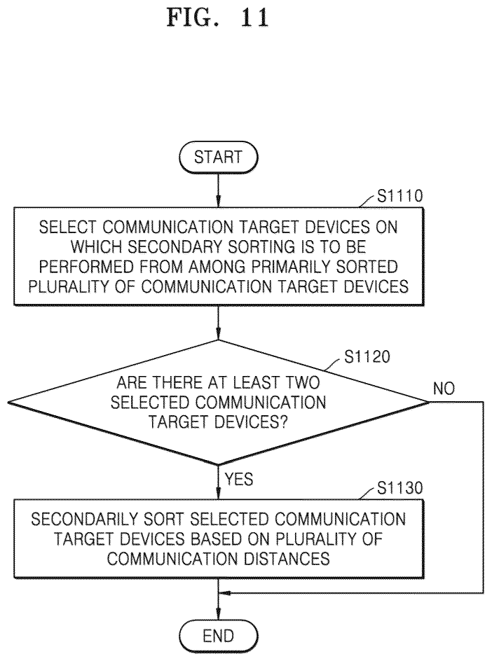

In operation S1020, the wireless communication device 100 may secondarily sort the plurality of communication target devices based on the plurality of communication distances. This may be described in more detail with reference to FIG. 11.

FIG. 11 is a flowchart illustrating a particular method of secondarily sorting the plurality of communication target devices in the operating method of a wireless communication device, according to an embodiment.

Referring to FIG. 11, in operation S1110, the wireless communication device 100 may perform an operation to select a subset of communication target devices that are eligible for secondary sorting, from among the primarily sorted plurality of communication target devices. This selection may be based on the beamwidth of the wireless communication device 100, for example, using Mathematical formula 1 above to determine whether the azimuthal separation between communication target devices fall within an acceptable range. This selection process may identify communication target devices that are directionally close enough to be reached by the same beam and are therefore valid candidates for secondary sorting.

In operation S1120, the wireless communication device 100 may determine whether the selection in operation S1110 has resulted in at least two communication target devices. If fewer than two communication target devices are selected, the second sorting may not be performed, and the method shown in FIG. 11 may end.

If at least two communication target devices are selected in operation S1130, the wireless communication device 100 may secondarily sort the selected communication target devices based on the plurality of communication distances. The secondary sorting may be performed in order of distances. In an embodiment, the wireless communication device 100 may secondarily sort the communication target devices selected to be secondarily sorted, in an ascending order of the plurality of communication distances. In another embodiment, the wireless communication device 100 may secondarily sort the communication target devices selected to be secondarily sorted, in a descending order of the plurality of communication distances.

Referring back to FIG. 9, in operation S940, the wireless communication device 100 may classify the sorted plurality of communication target devices into a plurality of user clusters. In an embodiment, the wireless communication device 100 may classify the sorted plurality of communication target devices into the plurality of user clusters such that the intervals between the sorting indices of communication target devices included in each of the plurality of user clusters are the same as each other. In another embodiment, the wireless communication device 100 may classify, into a same user cluster, communication target devices having the same remainder as the remainder of a result of dividing a sorting index by the number of user clusters.

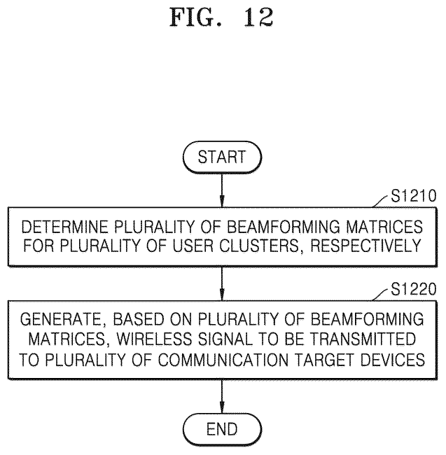

In operation S950, the wireless communication device 100 may generate a wireless signal to be transmitted to the plurality of communication target devices, based on the plurality of user clusters. This may be described in more detail with reference to FIG. 12.

FIG. 12 is a flowchart illustrating a method of generating a wireless signal in the operating method of a wireless communication device, according to an embodiment.

Referring to FIG. 12, in operation S1210, the wireless communication device 100 may determine a plurality of beamforming matrices for the plurality of user clusters, respectively.

In operation S1220, the wireless communication device 100 may generate a wireless signal to be transmitted to the plurality of communication target devices, based on the plurality of beamforming matrices. The wireless communication device 100 may generate a wireless signal by multiplying the plurality of beamforming matrices by a plurality of transmission target signals to be transmitted to the plurality of user clusters, respectively.

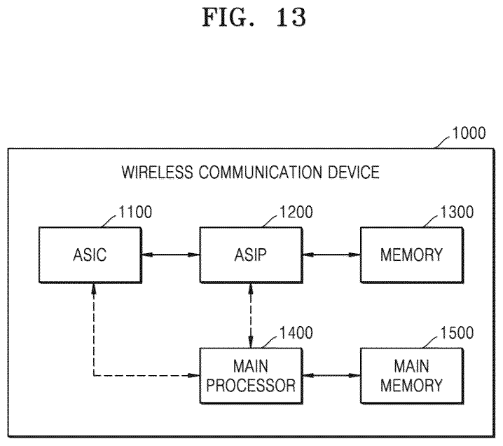

FIG. 13 is a block diagram illustrating a wireless communication device 1000 according to an embodiment.

Referring to FIG. 13, the wireless communication device 1000 may include an application specific integrated circuit (ASIC) 1100, an application specific instruction set processor (ASIP) 1200, a memory 1300, a main processor 1400, and a main memory 1500. Two or more of the ASIC 1100, the ASIP 1200, and the main processor 1400 may communicate with each other. In addition, two or more of the ASIC 1100, the ASIP 1200, the memory 1300, the main processor 1400, and the main memory 1500 may be embedded in one chip.

The ASIC 1100, as an integrated circuit customized for a particular usage, may include, for example, a radio frequency integrated circuit (RFIC), a modulator, a demodulator, and the like. The ASIP 1300 may support a dedicated instruction set for a particular application and execute instructions included in the instruction set. The memory 1300 may communicate with the ASIP 1200 and store, as a non-transitory storage device, a plurality of instructions to be executed by the ASIP 1200. For example, the memory 1300 may correspond to any type of memory accessible by the ASIP 1200, such as RAM, ROM, tape, a magnetic disk, an optical disc, a volatile memory, a nonvolatile memory, or a combination thereof.

The main processor 1400 may control the wireless communication device 1000 by executing a plurality of instructions. For example, the main processor 1400 may control the ASIC 1100 and the ASIP 1200 and process data received through a wireless communication network or a user's input on the wireless communication device 1000. The main memory 1500 may communicate with the main processor 1400 and store, as a non-transitory storage device, a plurality of instructions to be executed by the main processor 1400. For example, the main memory 1500 may include, for example, a random type of memory, such as RAM, ROM, tape, a magnetic disk, an optical disc, a volatile memory, a nonvolatile memory, or a combination thereof, accessible by the main processor 1400.

A component of the wireless communication device 100 according to an embodiment, which has been described with reference to FIGS. 1 to 12, may correspond to or be included in at least one of the components included in the wireless communication device 1000 of FIG. 13. For example, the processor 110 of the wireless communication device 100 of FIG. 2 may correspond to the ASIP 1200 of the wireless communication device 1000 of FIG. 13. The ASIP 1200 of FIG. 13 may classify a plurality of communication target devices into a plurality of user clusters based on a plurality of azimuths and a plurality of communication distances and transmit a wireless signal to the plurality of communication target devices based on the plurality of user clusters. As described above, by transmitting a wireless signal based on a generated plurality of user clusters, clustering may be performed to have high transmission efficiency with a small delay time, thereby transmitting the wireless signal at the high transmission efficiency.

In one or more embodiments of the present disclosure, an operating method of a wireless communication device for communicating with a plurality of communication target devices, may include: calculating a plurality of azimuth angles between the plurality of communication target devices and the wireless communication device, respectively; calculating a plurality of communication distances between the plurality of communication target devices and the wireless communication device, respectively; sorting the plurality of communication target devices based on the plurality of azimuth angles and the plurality of communication distances; grouping the sorted plurality of communication target devices into a plurality of user clusters; and generating, based on the plurality of user clusters, a wireless signal to be transmitted to the plurality of communication target devices.

The plurality of azimuth angles are respective angles between a plurality of connection lines and a central line of intersection. The plurality of connection lines are respective lines connecting centers of antenna arrays of the plurality of communication target devices to a central point of intersection of an antenna array of the wireless communication device. The central point of intersection may be a point of intersection between a center of the antenna array of the wireless communication device and ground when the antenna array of the wireless communication device is vertically projected onto the ground. The central line of intersection may be a line of intersection between the antenna array of the wireless communication device and the ground when the center of the antenna array of the wireless communication device is vertically projected onto the ground.

The plurality of communication distances may be respective distances between centers of antenna arrays of the plurality of communication target devices and a center of an antenna array of the wireless communication device.

The sorting may include: primarily sorting the plurality of communication target devices based on the plurality of azimuth angles; and secondarily sorting the primarily sorted plurality of communication target devices based on the plurality of communication distances.

The primarily sorting may include primarily sorting the plurality of communication target devices in an ascending or descending order of the plurality of azimuth angles.

The secondarily sorting may include: selecting communication target devices on which the secondary sorting is to be performed from among the primarily sorted plurality of communication target devices based on a beam width of the wireless communication device; and secondarily sorting the communication target devices selected to be secondarily sorted, in an ascending or descending order of the plurality of communication distances.

The grouping of the sorted plurality of communication target devices into the plurality of user clusters may include grouping the sorted plurality of communication target devices into the plurality of user clusters such that intervals between sorting indices of communication target devices included in each of the plurality of user clusters are identical.

The grouping of the sorted plurality of communication target devices into the plurality of user clusters may include assigning, into a same user cluster, communication target devices having a same remainder resulting from dividing respective sorting indices of the communication target devices by a number of user clusters.

The generating, based on the plurality of user clusters, the wireless signal to be transmitted to the plurality of communication target devices may include: determining a plurality of beamforming matrices for the plurality of user clusters, respectively; and generating, based on the plurality of beamforming matrices, the wireless signal to be transmitted to the plurality of communication target devices.

In one or more embodiments of the present disclosure, a wireless communication device for communicating with a plurality of communication target devices may include: a processor configured to generate a wireless signal; and a transceiver configured to transmit the wireless signal. The processor is further configured to: calculate a plurality of azimuth angles between the plurality of communication target devices and the wireless communication device, respectively; calculate a plurality of communication distances that are respective distances between the plurality of communication target devices and the wireless communication device; sort the plurality of communication target devices based on the plurality of azimuth angles and the plurality of communication distances; group the sorted plurality of communication target devices into a plurality of user clusters; and generate, based on the plurality of user clusters, the wireless signal to be transmitted to the plurality of communication target devices.

The plurality of azimuth angles may be respective angles between a plurality of connection lines and a central line of intersection. The plurality of connection lines may be respective lines connecting centers of antenna arrays of the plurality of communication target devices to a central point of intersection of an antenna array of the wireless communication device. The central point of intersection may be a point of intersection between a center of the antenna array of the wireless communication device and ground when the center of the antenna array of the wireless communication device is vertically projected onto the ground. The central line of intersection may be a line of intersection between the antenna array of the wireless communication device and the ground when the center of the antenna array of the wireless communication device is vertically projected onto the ground.

The plurality of communication distances may be respective distances between centers of antenna arrays of the plurality of communication target devices and a center of an antenna array of the wireless communication device.

The processor may be further configured to: primarily sort the plurality of communication target devices based on the plurality of azimuth angles; and secondarily sort the primarily sorted plurality of communication target devices based on the plurality of communication distances.

The processor may be further configured to primarily sort the plurality of communication target devices in an ascending or descending order of the plurality of azimuth angles.

The processor may be further configured to: select communication target devices on which the secondary sorting is to be performed from among the primarily sorted plurality of communication target devices based on a beam width of the wireless communication device; and secondarily sort the communication target devices selected to be secondarily sorted, in an ascending or descending order of the plurality of communication distances.

The processor may be further configured to group the sorted plurality of communication target devices into the plurality of user clusters such that intervals between sorting indices of communication target devices included in each of the plurality of user clusters are identical.

The processor may be further configured to assign, into a same user cluster, communication target devices having a same remainder resulting from dividing respective sorting indices of the communication target devices by a number of user clusters.

The processor may be further configured to: determine a plurality of beamforming matrices for the plurality of user clusters, respectively; and generate, based on the plurality of beamforming matrices, the wireless signal to be transmitted to the plurality of communication target devices.

In one or more embodiments of the present disclosure, a method of controlling a base station may include: sorting a plurality of user terminals based on respective azimuth angles between the base station and the plurality of user terminals, and respective communication distances between the base station and the plurality of user terminals; grouping the sorted plurality of user terminals into a plurality of user clusters, by assigning, into a same user cluster, user terminals having an identical remainder resulting from dividing respective sorting indices of the user terminals by a total number of user clusters; and generating, based on the plurality of user clusters, a wireless signal to be transmitted to the plurality of user terminals.

The sorting may include: primarily sorting the plurality of user terminals in an ascending or descending order of the respective azimuth angles; and secondarily sorting the primarily sorted plurality of user terminals in an ascending or descending order of the respective communication distances.

While the inventive concept has been particularly shown and described with reference to embodiments thereof, it will be understood that various changes in form and details may be made therein without departing from the spirit and scope of the following claims.

What is claimed is:

1. An operating method of a wireless communication device for communicating with a plurality of communication target devices, the operating method comprising:
calculating a plurality of azimuth angles between the plurality of communication target devices and the wireless communication device, respectively;
calculating a plurality of communication distances between the plurality of communication target devices and the wireless communication device, respectively;
sorting the plurality of communication target devices based on the plurality of azimuth angles and the plurality of communication distances;
grouping the sorted plurality of communication target devices into a plurality of user clusters; and
generating, based on the plurality of user clusters, a wireless signal to be transmitted to the plurality of communication target devices.

2. The operating method of claim 1, wherein the plurality of azimuth angles are respective angles between a plurality of connection lines and a central line of intersection,
the plurality of connection lines are respective lines connecting centers of antenna arrays of the plurality of communication target devices to a central point of intersection of an antenna array of the wireless communication device,
the central point of intersection is a point of intersection between a center of the antenna array of the wireless communication device and ground when the antenna array of the wireless communication device is vertically projected onto the ground, and
the central line of intersection is a line of intersection between the antenna array of the wireless communication device and the ground when the center of the antenna array of the wireless communication device is vertically projected onto the ground.

3. The operating method of claim 1, wherein the plurality of communication distances are respective distances between centers of antenna arrays of the plurality of communication target devices and a center of an antenna array of the wireless communication device.

4. The operating method of claim 1, wherein the sorting comprises:
primarily sorting the plurality of communication target devices based on the plurality of azimuth angles; and
secondarily sorting the primarily sorted plurality of communication target devices based on the plurality of communication distances.

5. The method of claim 4, wherein the primarily sorting comprises primarily sorting the plurality of communication target devices in an ascending or descending order of the plurality of azimuth angles.

6. The operating method of claim 4, wherein the secondarily sorting comprises:
selecting communication target devices on which the secondary sorting is to be performed from among the primarily sorted plurality of communication target devices based on a beam width of the wireless communication device; and
secondarily sorting the communication target devices selected to be secondarily sorted, in an ascending or descending order of the plurality of communication distances.

7. The operating method of claim 1, wherein the grouping of the sorted plurality of communication target devices into the plurality of user clusters comprises grouping the sorted plurality of communication target devices into the plurality of user clusters such that intervals between sorting indices of communication target devices included in each of the plurality of user clusters are identical.

8. The operating method of claim 1, wherein the grouping of the sorted plurality of communication target devices into the plurality of user clusters comprises assigning, into a same user cluster, communication target devices having a same remainder resulting from dividing respective sorting indices of the communication target devices by a number of user clusters.

9. The operating method of claim 1, wherein the generating, based on the plurality of user clusters, the wireless signal to be transmitted to the plurality of communication target devices comprises:
determining a plurality of beamforming matrices for the plurality of user clusters, respectively; and
generating, based on the plurality of beamforming matrices, the wireless signal to be transmitted to the plurality of communication target devices.

10. A wireless communication device for communicating with a plurality of communication target devices, the wireless communication device comprising:
a processor configured to generate a wireless signal; and
a transceiver configured to transmit the wireless signal,
wherein the processor is further configured to:
calculate a plurality of azimuth angles between the plurality of communication target devices and the wireless communication device, respectively;
calculate a plurality of communication distances that are respective distances between the plurality of communication target devices and the wireless communication device;
sort the plurality of communication target devices based on the plurality of azimuth angles and the plurality of communication distances;
group the sorted plurality of communication target devices into a plurality of user clusters; and
generate, based on the plurality of user clusters, the wireless signal to be transmitted to the plurality of communication target devices.

11. The wireless communication device of claim 10, wherein the plurality of azimuth angles are respective angles between a plurality of connection lines and a central line of intersection,
the plurality of connection lines are respective lines connecting centers of antenna arrays of the plurality of communication target devices to a central point of intersection of an antenna array of the wireless communication device,
the central point of intersection is a point of intersection between a center of the antenna array of the wireless communication device and ground when the center of the antenna array of the wireless communication device is vertically projected onto the ground, and
the central line of intersection is a line of intersection between the antenna array of the wireless communication device and the ground when the center of the antenna array of the wireless communication device is vertically projected onto the ground.

12. The wireless communication device of claim 10, wherein the plurality of communication distances are respective distances between centers of antenna arrays of the plurality of communication target devices and a center of an antenna array of the wireless communication device.

13. The wireless communication device of claim 10, wherein the processor is further configured to:
primarily sort the plurality of communication target devices based on the plurality of azimuth angles; and
secondarily sort the primarily sorted plurality of communication target devices based on the plurality of communication distances.

14. The wireless communication device of claim 13, wherein the processor is further configured to primarily sort the plurality of communication target devices in an ascending or descending order of the plurality of azimuth angles.

15. The wireless communication device of claim 13, wherein the processor is further configured to:
select communication target devices on which the secondary sorting is to be performed from among the primarily sorted plurality of communication target devices based on a beam width of the wireless communication device; and
secondarily sort the communication target devices selected to be secondarily sorted, in an ascending or descending order of the plurality of communication distances.

16. The wireless communication device of claim 10, wherein the processor is further configured to group the sorted plurality of communication target devices into the plurality of user clusters such that intervals between sorting indices of communication target devices included in each of the plurality of user clusters are identical.

17. The wireless communication device of claim 10, wherein the processor is further configured to assign, into a same user cluster, communication target devices having a same remainder resulting from dividing respective sorting indices of the communication target devices by a number of user clusters.

18. The wireless communication device of claim 10, wherein the processor is further configured to:
determine a plurality of beamforming matrices for the plurality of user clusters, respectively; and
generate, based on the plurality of beamforming matrices, the wireless signal to be transmitted to the plurality of communication target devices.

19. A method of controlling a base station, the method comprising:
sorting a plurality of user terminals based on respective azimuth angles between the base station and the plurality of user terminals, and respective communication distances between the base station and the plurality of user terminals;
grouping the sorted plurality of user terminals into a plurality of user clusters, by assigning, into a same user cluster, user terminals having an identical remainder resulting from dividing respective sorting indices of the user terminals by a total number of user clusters; and
generating, based on the plurality of user clusters, a wireless signal to be transmitted to the plurality of user terminals.

20. The method of claim 19, wherein the sorting comprises:
primarily sorting the plurality of user terminals in an ascending or descending order of the respective azimuth angles; and
secondarily sorting the primarily sorted plurality of user terminals in an ascending or descending order of the respective communication distances.
